(19) United States
(12) Patent Application Publication
(10) Pub. No.: US 2023/0007949 A1
(43) Pub. Date: Jan. 12, 2023

(54) Optical Device

(71) Applicant: Nippon Telegraph and Telephone Corporation, Tokyo (JP)

(72) Inventor: Hidetaka Nishi, Tokyo (JP)

(21) Appl. No.: 17/793,529

(22) PCT Filed: Jan. 22, 2020
(86) PCT No.: PCT/JP2020/002090

§ 371 Date: Jul. 18, 2022

(51) Int. Cl. G02F 1/035

(52) U.S. Cl. CPC G02F 1/035

(57) ABSTRACT

A phase shifter includes a first cladding layer, a first core formed on the first cladding layer, and a second core formed on the first core. The first cladding layer and the first core are formed from a first material having an electrooptical effect. The second core is formed from a second material having a refractive index higher than that of the first material. The phase shifter includes a first metal layer and a second metal layer formed on side surfaces of both of the first core and the second core.

### CROSS-REFERENCE TO RELATED APPLICATIONS

This application is a national phase entry of PCT Application No. PCT/JP2020/002090, filed on Jan. 22, 2020, which application is hereby incorporated herein by reference.

### TECHNICAL FIELD

The present invention relates to an optical device including an electrooptical material.

### BACKGROUND

Optical waveguide-type high-speed phase shifters have been researched and developed as a key device to achieve Tbit/s-class ultra-high speed optical communication, millimeter wave communication, and terahertz wave communication. Among the optical waveguide-type high-speed phase shifters, an operating principle of a high-speed phase shifter including, for example, an optical waveguide whose core is formed from an electrooptical (EO) material is a dielectric response by an external modulation electric field to produce a change in refractive index. This high-speed phase shifter has a feature that it operates at higher speed than a phase shifter including a semiconductor material that changes a refractive index by movement of a carrier within the core.

In recent years, it has been reported that a frequency response of 100 GHz or more has been achieved by a high-speed phase shifter including an optical waveguide whose core is formed from an EO polymer or an EO material such as lithium niobate. These phase shifters are reported as optical modulators integrated with a high performance passive optical circuit including an optical waveguide (Si optical waveguide) with a Si core (see NPL 1).

In this technique, an LNOI (LN on Insulator) substrate in which a thin film (LN thin film) of lithium niobate (LN) is formed on an insulating substrate is used, and the LN thin film formed on the substrate is used by being bonded onto an SOI substrate on which an optical circuit including an Si optical waveguide is formed. In the optical waveguide of the phase shifter portion, light is leaked into the LN thin film by narrowing an Si core width, so that a propagation mode is provided in which a light intensity distribution is present in both the Si core and the LN thin film, and a phase change is imparted to this mode based on a change in refractive index caused by an electric field applied to the LN thin film. The LN thin film has no light confinement structure in a horizontal direction of a light confinement substrate, and light confinement cannot be enhanced, so that a modulation efficiency VπL is as large as 6.7 Vcm.

In the technique of NPL 2, in order to obtain the light confinement structure in a LN waveguide as in NPL 1, the LN thin film formed on the LNOI substrate is bonded onto the SOI substrate on which the Si optical circuit is produced. Unlike NPL 1, by processing the LN thin film into a ridge-type waveguide structure, light confinement is also achieved in the substrate horizontal direction, light is completely transferred from the Si optical circuit to the LN optical waveguide, and the ridge-type waveguide structure is used as the optical waveguide of the phase shifter portion. In the LN optical waveguide, relatively strong light confinement can be achieved by utilizing a high refractive index difference between LN and SiO2; however, the distance between electrodes for applying an electric field to the core is several um, which limits the strength of the electric field that can be applied to the EO material, and VπL is as large as 2.2 Vcm.

As described above, a waveguide type phase shifter including the optical waveguide whose core is formed from the EO material is capable of high-speed operation, but has problems with operating efficiency and driving voltage.

Aside from the optical waveguide including the EO material described above, in recent years, an optical modulator in which a plasmonic optical waveguide is used for a phase shifter has been achieved for further increasing efficiency and lowering driving voltage. Unlike optical waveguides in the related art, the plasmonic optical waveguide can confine light in a very narrow region that is equal to or narrower than a light diffraction limit. Light having a wavelength of 1.3 μm or 1.5 μm is confined in the core formed from the EO material having a width of 100 nm or less, for example, by using a waveguide structure formed from, for example, metal-EO material-metal (hereinafter referred to as a MEM structure).

In this technique, metal for confining light can also be used for an electrode of the phase shifter, and a modulation electric field can be applied to the EO material at an electrode spacing equal to or less than 100 nm that is the core width described above. In addition, the optical modulator including the plasmonic optical waveguide described above has a feature that extremely high modulation efficiency can be obtained because there is a large overlap between electric field intensity distributions of high frequency magnetic fields of propagation light and a modulation signal.

### CITATION LIST

### Non Patent Literature

NPL 1: P. O. Weigel et al., “Bonded thin film lithium niobate modulator on a silicon photonics platform exceeding 100 GHz 3-dB electrical modulation bandwidth”, Optics Express, vol. 26, no. 18, pp. 23728-23739, 2018.

NPL 2: M. He et al., “High-performance hybrid silicon and lithium niobate Mach-Zehnder modulators for 100 Gbit s-1 and beyond”, Nature Photonics, vol. 13, pp. 359-364, 2019.

NPL 3: B. Baeuerle et al., “Driver-Less Sub 1 Vpp Operation of a Plasmonic-Organic Hybrid Modulator at 100 GBd NRZ”, Optical Fiber Communication Conference, Optical Society of America, ISBN: 978-1-943580-38-5, 2018.

NPL 4: A. Messner et al., “Plasmonic Ferroelectric Modulators”, Journal of Lightwave Technology, vol. 37, no. 2, pp. 281-290, 2019.

### SUMMARY

### Summary of the Invention

### Technical Problem

However, the phase shifter including the plasmonic optical waveguide whose core is formed from the EO material has the following problems.

For example, in the phase shifter including the plasmonic optical waveguide disclosed in NPL 3, a material that can utilize an EO effect as the core is limited to a material that is applied or deposited to fill a gap of several tens of nanometers and can exhibit the EO effect after a metal structure constituting the Si optical waveguide and the plasmonic optical waveguide is formed, and only an EO polymer material has been used.

In NPL 4, a thin film of BaTiO3 grown via a buffer layer by molecular beam epitaxy on a substrate made of monocrystalline silicon with a plane orientation of a main surface being (100) is used as the EO material; however, only a very small EO coefficient that greatly differs from the EO coefficient of ideal crystal has been obtained.

The present invention has been made to solve the problems described above, and an object of embodiments of the present invention is to provide a phase shifter capable of a lower driving voltage operation with higher efficiency by using a plasmonic optical waveguide including a core formed from an electrooptical material in which a higher electrooptical coefficient can be obtained.

### Means for Solving the Problem

An optical device according to embodiments of the present invention includes: a first cladding layer formed from a first material having an electrooptical effect; a first core formed on the first cladding layer and formed from the first material; a second core formed on the first core and formed from a second material having a refractive index higher than a refractive index of the first material; a first metal layer and a second metal layer formed on side surfaces of both of the first core and the second core; and a second cladding layer formed on the first cladding layer to cover the first core, the second core, the first metal layer, and the second metal layer, wherein the first core, the second core, the first metal layer, and the second metal layer constitute a plasmonic optical waveguide.

### Effects of the Invention

As described above, according to embodiments of the present invention, it is possible to provide a phase shifter capable of a lower driving voltage operation with higher efficiency by using the plasmonic optical waveguide including the core formed from an electrooptical material in which a higher electrooptical coefficient can be obtained.

### BRIEF DESCRIPTION OF THE DRAWINGS

FIG. 1 is a cross-sectional view illustrating a configuration of an optical device according to a first embodiment of the present invention.

FIG. 2 is a perspective view illustrating the configuration of the optical device according to the first embodiment of the present invention.

FIG. 3 is a distribution diagram illustrating an electric field intensity distribution in a cross section perpendicular to a waveguide direction of the optical device according to the first embodiment of the present invention.

FIG. 4A is a distribution diagram illustrating the electric field intensity distribution in the cross section perpendicular to the waveguide direction of the optical device according to the first embodiment of the present invention.

FIG. 4B is a distribution diagram illustrating the electric field intensity distribution in the cross section perpendicular to the waveguide direction of the optical device according to the first embodiment of the present invention.

FIG. 5 is a distribution diagram illustrating the electric field intensity distribution in the cross section perpendicular to the waveguide direction of the optical device according to the first embodiment of the present invention.

FIG. 6A is a distribution diagram illustrating the electric field intensity distribution in the cross section perpendicular to the waveguide direction of the optical device according to the first embodiment of the present invention.

FIG. 6B is a distribution diagram illustrating the electric field intensity distribution in the cross section perpendicular to the waveguide direction of the optical device according to the first embodiment of the present invention.

FIG. 7 is a cross-sectional view illustrating a configuration of an optical device according to a second embodiment of the present invention.

FIG. 8 is a distribution diagram illustrating an electric field intensity distribution in a cross section perpendicular to a waveguide direction of the optical device according to the second embodiment of the present invention.

FIG. 9A is a distribution diagram illustrating the electric field intensity distribution in the cross section perpendicular to the waveguide direction of the optical device according to the second embodiment of the present invention.

FIG. 9B is a distribution diagram illustrating the electric field intensity distribution in the cross section perpendicular to the waveguide direction of the optical device according to the second embodiment of the present invention.

FIG. 10 is a cross-sectional view illustrating a configuration of an optical device according to a third embodiment of the present invention.

FIG. 11 is a perspective view illustrating a configuration of an application example of the optical device according to the embodiment of the present invention.

### DETAILED DESCRIPTION OF ILLUSTRATIVE EMBODIMENTS

Hereinafter, optical devices according to embodiments of the present invention will be described.

### First Embodiment

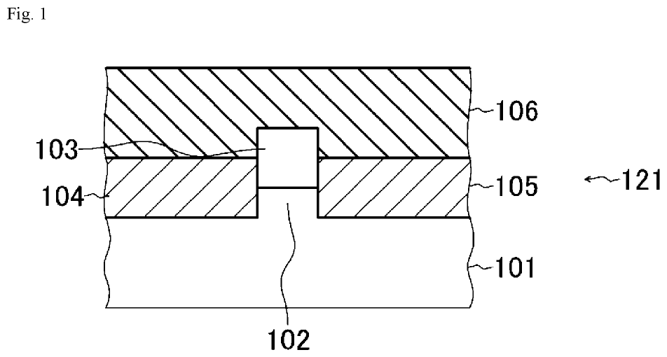

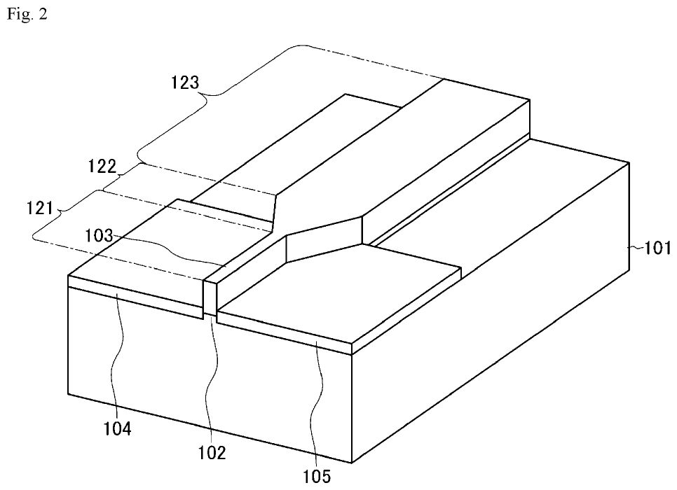

First, an optical device according to a first embodiment of the present invention will be described with reference to FIGS. 1 and 2. FIG. 1 illustrates a cross section of a surface perpendicular to a waveguide direction. The optical device first includes a phase shifter 121. The phase shifter 121 includes a first cladding layer 101, a first core 102 formed on the first cladding layer 101, and a second core 103 formed on the first core 102. In the first embodiment, the first cladding layer 101 and the first core 102 are integrally formed. The first core 102 having this configuration is a so-called ridge type core.

The first cladding layer 101 and the first core 102 are formed from a first material having an electrooptical effect. The first material can be composed of lithium niobate (LiNbO3), for example. The second core 103 is formed from a second material having a refractive index higher than that of the first material. The second material constituting the second core 102 can be at least one of silicon (Si), InP, or AlGaAs, for example.

The phase shifter 121 includes a first metal layer 104 and a second metal layer 105 formed on side surfaces of both of the first core 102 and the second core 103. Taking into account light coupling described below, the first metal layer 104 and the second metal layer 105 may be formed up to the middle of the second core 103 in a thickness direction, for example. The first core 102, the second core 103, the first metal layer 104, and the second metal layer 105 constitute a plasmonic optical waveguide. In the first embodiment, the first metal layer 104 and the second metal layer 105 are formed in contact with side surfaces of both of the first core 102 and the second core 103. The first metal layer 104 and the second metal layer 105 can be formed from aluminum (Al), for example.

The phase shifter 121 includes a second cladding layer 106 formed above the first cladding layer 101 so as to cover the first core 102, the second core 103, the first metal layer 104, and the second metal layer 105. The second cladding layer 106 can be formed from a material having a lower refractive index than the second core 103. The second cladding layer 106 can be formed from silicon oxide, for example. The second cladding layer 106 may be air.

In the optical device according to the first embodiment, the first core 102 and the second core 103 of the phase shifter 121 described above include, on an end side, a mode conversion region 122 in which a width (core width) in a plan view gradually expands in the waveguide direction. The mode conversion region 122 is formed continuously with the phase shifter 121. The optical device according to the first embodiment includes an optical waveguide region 123 following the mode conversion region 122. The optical waveguide region 123 includes the first core 102, the second core 103, and the second cladding layer 106 covering the first core 102 and the second core 103, and the first metal layer 104 and the second metal layer 105 are not formed. In the optical waveguide region 123, the core width of the first core 102 and the second core 103 is wider than the core width in the phase shifter 121.

By using the mode conversion region 122, the optical waveguide region 123 and the plasmonic optical waveguide constituting the phase shifter 121 can be integrated onto the same substrate.

Here, a relationship between a thickness (core height) of the first core 102 and thicknesses (metal layer thicknesses) of the first metal layer 104 and the second metal layer 105 will be described. The thickness of the first core 102 and the thicknesses of the metal layers are important design considerations for the phase shifter (plasmonic optical waveguide). When the thicknesses of the metal layers are smaller than the first core 102 and reach a side portion of the second core 103, the light coupling from the phase shifter 121 to the optical waveguide region 123 is facilitated.

However, when the thicknesses of the metal layers are smaller than the first core 102 and reach the side portion of the second core 103, there is a concern that intensity of light propagating in the plasmonic optical waveguide of the phase shifter 121 is distributed to the outside of the second core 103 (second core 103), so that modulation efficiency in the phase shifter 121 is deteriorated.

On the other hand, when the thicknesses of the metal layers are smaller than the first core 102 and do not reach the side portion of the second core 103, in the plasmonic optical waveguide of the phase shifter 121, an existence ratio of the propagating light intensity into the second core 103 increases, so that high modulation efficiency in the phase shifter 121 is obtained. However, in this configuration, the ease of the light coupling from the phase shifter 121 to the optical waveguide region 123 is reduced.

According to the above, the thicknesses of the first metal layer 104 and the second metal layer 105 are designed taking into account a tradeoff between the efficiency in the phase shifter 121 and the ease of the light coupling from the phase shifter 121 to the optical waveguide region 123.

Although the first cladding layer 101 can be formed from a wafer of a material having an electrooptical effect, embodiments of the present invention is not limited thereto. Some of the materials having the electrooptical effect have a high EO coefficient physically, but are difficult to crystal-grow in a wafer form. The optical device according to the embodiment may be formed, for example, on a piece of an EO material cut into 20 mm square. For example, as long as the second material and a metal material can be deposited on the piece of the EO material, the deposited second material layer and the deposited metal layer can be patterned or processed, and a minute depth of the EO material can be processed, the optical device can be produced. The optical device according to the embodiment can be produced even with the EO material having an excellent EO coefficient, which has been difficult to form a strong light confinement structure. In other words, the EO material having an excellent EO coefficient, which has been difficult to form the strong light confinement structure, can be applied to the optical device according to the embodiment.

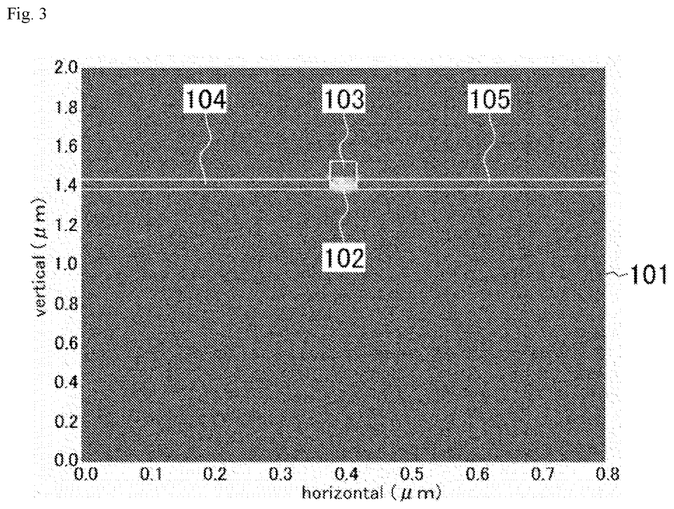

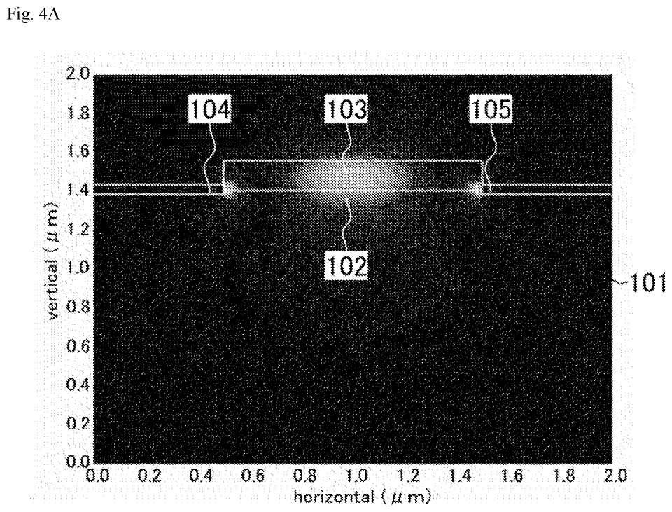

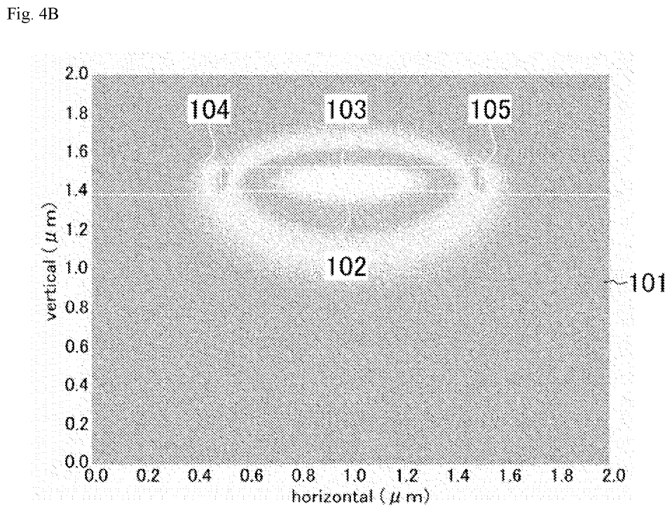

Here, an electric field intensity distribution in a cross section perpendicular to a waveguide direction of the optical device according to the first embodiment will be described. First, the electric field intensity distribution under a first condition is illustrated in FIGS. 3, 4A, and 4B. FIG. 3 illustrates the phase shifter 121, FIG. 4A illustrates the mode conversion region 122, and FIG. 4B illustrates the optical waveguide region 123.

For the first condition, first, the second material is Si. The thickness of the second core 103 is 120 nm. The first material is lithium niobate. The widths of the first core 102 and the second core 103 are 40 nm. The metal material is Al. The thickness of the first core 102 is 20 nm, and the thicknesses of the first metal layer 104 and the second metal layer 105 are 50 nm. The electric field intensity distribution in a light propagation mode at a wavelength of 1.55 μm in the optical waveguide of each region obtained by numerical calculation is illustrated.

First, as illustrated in FIG. 3, light is strongly confined inside the first core 102 and the second core 103 in a minute gap of 40 nm between the first metal layer 104 and the second metal layer 105. As illustrated in FIGS. 4A and 4B, it can be seen that there is a propagation mode in which mutual light intensity distributions greatly overlap in the mode conversion region 122 (FIG. 4A) in order to efficiently optically connect the phase shifter 121 (FIG. 3) and the optical waveguide region 123 (FIG. 4B).

Si can be deposited as an amorphous material at a low temperature, and an optical waveguide whose core is formed from Si is already widely reported as a low-loss optical waveguide. Thus, it is possible to produce the optical waveguide at equal to or less than a Curie point of lithium niobate serving as a substrate, and it is possible to form the optical waveguide including the second core 103 without deteriorating characteristics of the first core 102 formed from lithium niobate.

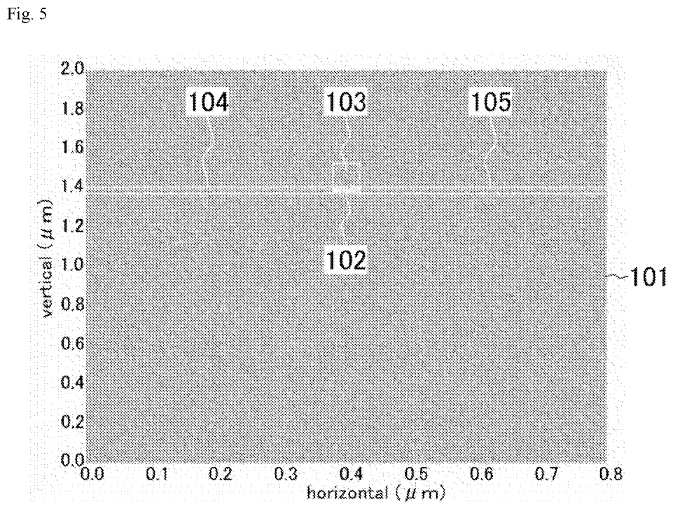

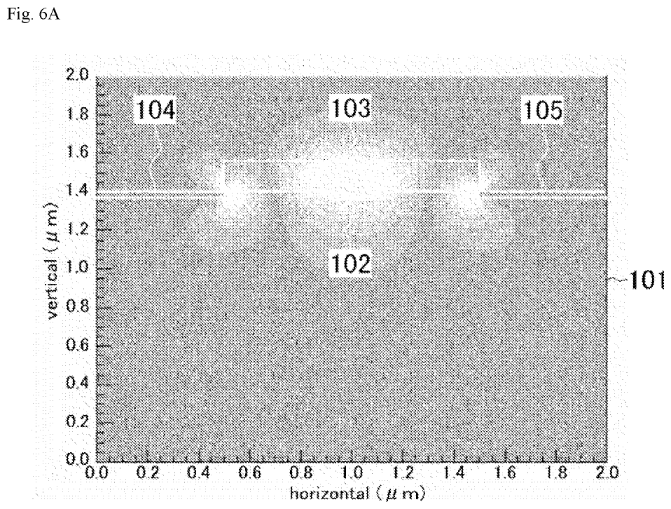

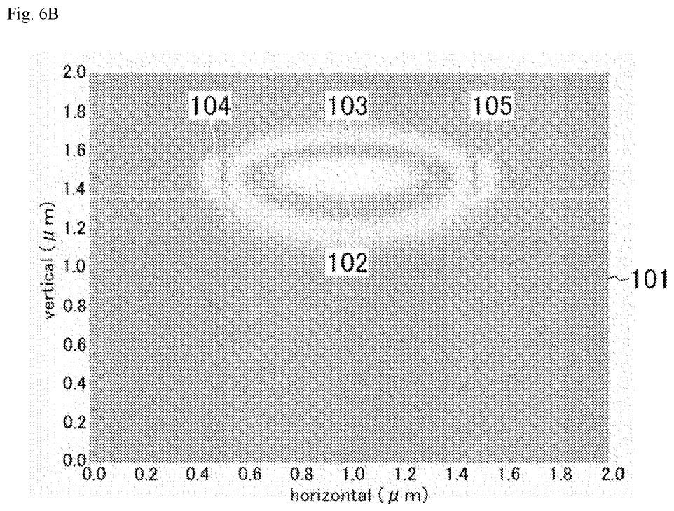

Next, the electric field intensity distribution under a second condition is illustrated in FIGS. 5, 6A, and 6B. FIG. 5 illustrates the phase shifter 121, FIG. 6A illustrates the mode conversion region 122, and FIG. 6B illustrates the optical waveguide region 123.

For the second condition, first, the second material is Si. The thickness of the second core 103 is 160 nm. The first material is lithium niobate. The widths of the first core 102 and the second core 103 are 40 nm. The metal material is Al. The thickness of the first core 102 is 30 nm, and the thicknesses of the first metal layer 104 and the second metal layer 105 are 30 nm. The electric field intensity distribution in a light propagation mode at a wavelength of 1.55 μm in the optical waveguide of each region obtained by numerical calculation is illustrated. In the second condition, the thickness of the first core 102 and the thicknesses of the first metal layer 104 and the second metal layer 105 are the same. With this configuration, a light intensity distribution ratio inside the first core 102 in the plasmonic optical waveguide can be further increased.

As illustrated in FIG. 5, light is strongly confined inside the first core 102 in the minute gap of 40 nm between the first metal layer 104 and the second metal layer 105. As illustrated in FIGS. 6A and 6B, it can be seen that there is a propagation mode in which mutual light intensity distributions greatly overlap in the mode conversion region 122 (FIG. 6A) in order to efficiently optically connect the phase shifter 121 (FIG. 5) and the optical waveguide region 123 (FIG. 6B).

### Second Embodiment

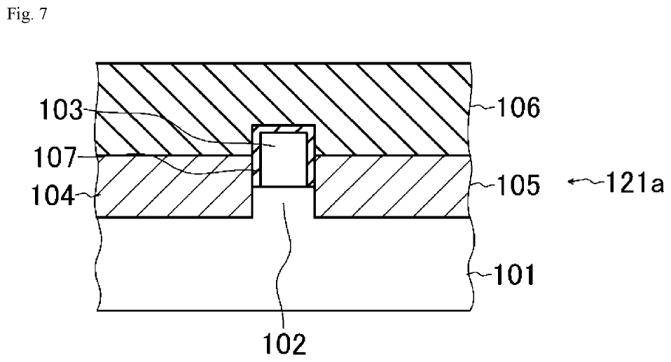

Next, an optical device according to a second embodiment of the present invention will be described with reference to FIG. 7. The optical device includes a phase shifter 121a. The phase shifter 121a includes a first cladding layer 101, a first core 102 formed on the first cladding layer 101, and a second core 103 formed on the first core 102. In the second embodiment, the first cladding layer 101 and the first core 102 are integrally formed. The phase shifter 121a includes a first metal layer 104 and a second metal layer 105 formed on side surfaces of both of the first core 102 and the second core 103.

The optical device according to the second embodiment includes a mode conversion region 122 formed following the phase shifter 121a and an optical waveguide region 123 formed following the mode conversion region 122.

The configuration described above is similar to that of the first embodiment described above, and the second embodiment further includes a layer 107 formed between side surfaces of both of the first and second cores 102 and 103 and the first and second metal layers 104 and 105 and formed from a third material having a refractive index lower than that of the second material. In the second embodiment, the layer 107 is also formed on a top surface of the second core 103 as well as on the both side surfaces. The layer 107 is provided in the phase shifter 121a and the mode conversion region 122.

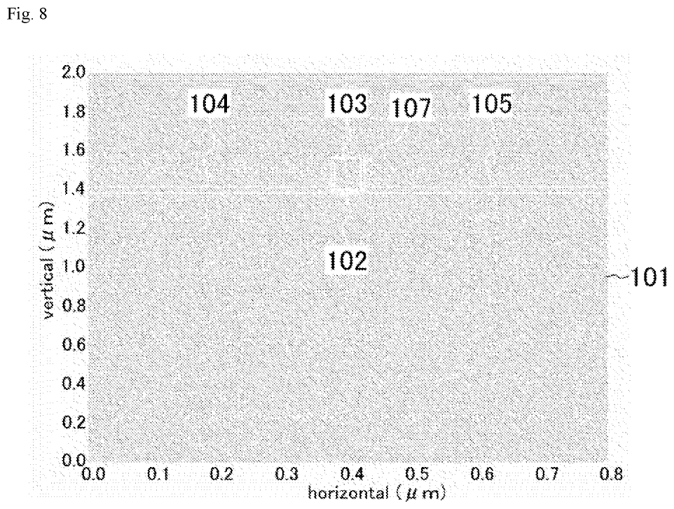

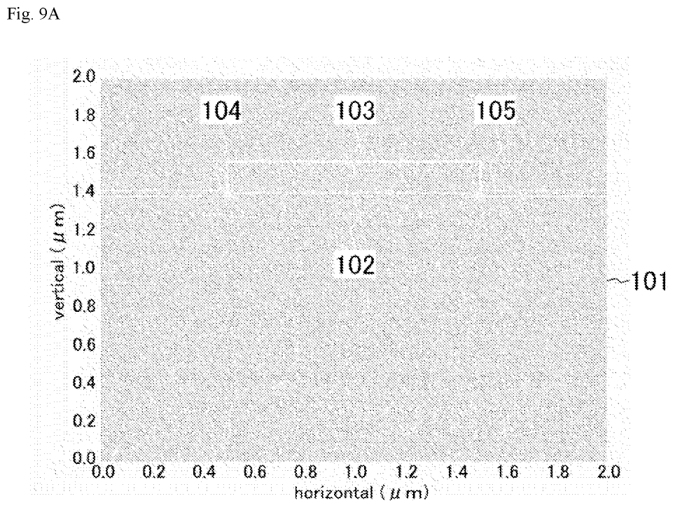

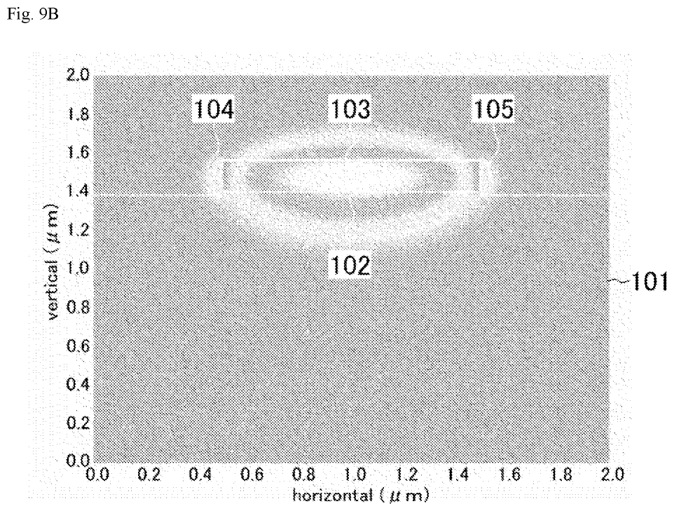

Here, the electric field intensity distribution in a cross section perpendicular to the waveguide direction of the optical device according to the second embodiment will be described with reference to FIGS. 8, 9A, and 9B. FIG. 8 illustrates the phase shifter 121a, FIG. 9A illustrates the mode conversion region 122, and FIG. 9B illustrates the optical waveguide region 123.

First, the second material is Si. The thickness of the second core 103 is 160 nm. The first material is lithium niobate. The widths of the first core 102 and the second core 103 are 40 nm. The metal material is Al. The thickness of the first core 102 is 20 nm, and the thicknesses of the first metal layer 104 and the second metal layer 105 are 30 nm. The layer 107 is formed from SiO2 and has a thickness of 0.6 nm. The electric field intensity distribution in a light propagation mode at a wavelength of 1.55 μm in the optical waveguide of each region obtained by numerical calculation is illustrated.

First, as illustrated in FIG. 8, light is strongly confined inside the layer 107 between the second core 103 and the first and second metal layers 104 and 105. In addition, light is also strongly confined inside the first core 102 in a minute gap of 40 nm between the first metal layer 104 and the second metal layer 105.

As illustrated in FIGS. 9A and 9B, it can be seen that there is a propagation mode in which mutual light intensity distributions greatly overlap in the mode conversion region 122 (FIG. 9A) in order to efficiently optically connect the phase shifter 121a (FIG. 8) and the optical waveguide region 123 (FIG. 9B).

### Third Embodiment

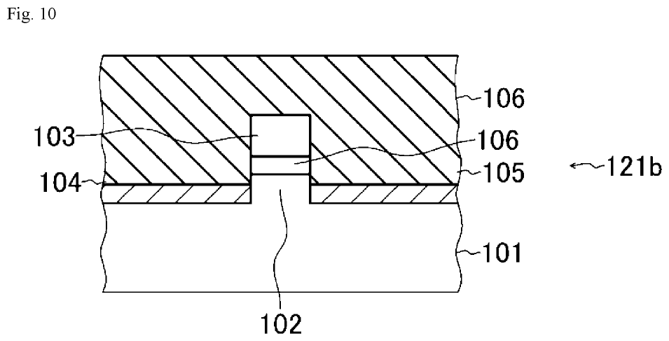

Next, an optical device according to a third embodiment of the present invention will be described with reference to FIG. 10. The optical device includes a phase shifter 121b. The phase shifter 121b includes a first cladding layer 101, a first core 102 formed on the first cladding layer 101, and a second core 103 formed above the first core 102. In the third embodiment, the first cladding layer 101 and the first core 102 are integrally formed. The phase shifter 121C includes a first metal layer 104 and a second metal layer 105 formed on side surfaces of both of the first core 102 and the second core 103.

The optical device according to the third embodiment includes a mode conversion region 122 formed following the phase shifter 121a and an optical waveguide region 123 formed following the mode conversion region 122.

The configuration described above is similar to that of the first embodiment described above, and the third embodiment further includes a bonding layer 108 formed between the first core 102 and the second core metal layer 103 and formed from a third material having a refractive index lower than that of the second material. In the third embodiment, the bonding layer 108 is provided in the phase shifter 121a and the mode conversion region 122.

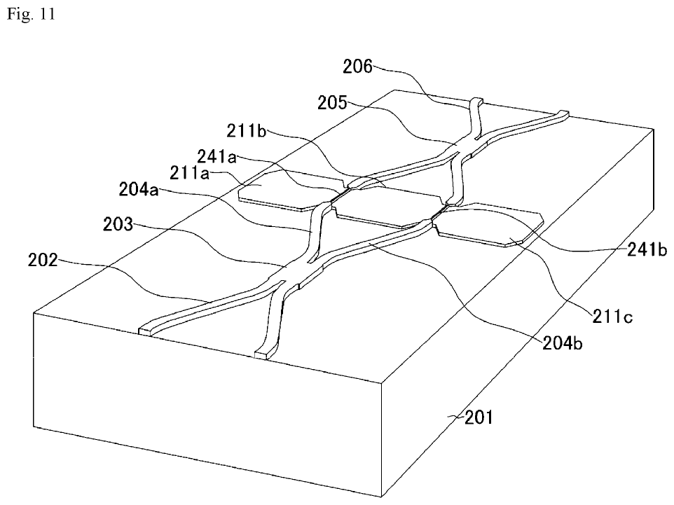

Next, an application example of the optical device according to the embodiment of the present invention will be described with reference to FIG. 11. The optical device can be applied to a so-called Mach-Zehnder interferometer type optical modulator. The Mach-Zehnder interferometer type optical modulator includes a first optical waveguide 202, a first multiplexer/demultiplexer 203, a first arm 204a, a second arm 204b, a second multiplexer/demultiplexer 205, and a second optical waveguide 206 on a substrate 201 serving as a first cladding layer. The core in each optical waveguide and each arm includes the first core and the second core described above.

A first plasmonic optical waveguide 241a is formed in the middle of the first arm 204a, and a second plasmonic optical waveguide 241b is formed in the middle of the second arm 204b. In each plasmonic optical waveguide, the core width is narrowed, and a metal layer 211a, a metal layer 211b, and a metal layer 211c are formed on both sides of the cores. The first plasmonic optical waveguide 241a is sandwiched between the metal layer 211a and the metal layer 211b. The second plasmonic optical waveguide 241b is sandwiched between the metal layer 211b and the metal layer 211c. Each plasmonic optical waveguide constitutes the phase shifter described above. The metal layer 211a, the metal layer 211b, and the metal layer 211c can be electrodes for inputting a high-frequency modulated electric signal to the phase shifter.

Although the Mach-Zehnder interferometer has been described above as the application example of the optical device according to embodiments of the present invention, intensity or phase of an output optical signal can be changed by combining various resonators and the like with the phase shifter and changing the refractive index inside the resonator.

As described above, in embodiments of the present invention, the second core formed from the second material having a refractive index higher than that of the first material is provided on or above the first material first core having the electrooptical effect, and the first metal layer and the second metal layer are disposed on the both sides of the cores, so that the plasmonic optical waveguide is formed. As a result, according to embodiments of the present invention, it is possible to provide a phase shifter capable of a lower driving voltage operation with higher efficiency by using the plasmonic optical waveguide including the core formed from an electrooptical material in which a higher electrooptical coefficient can be obtained.

Here, a material having a refractive index greater than that of a lower clad or the first core and having high optical transmittance at the wavelength to be propagated can be applied as the second material constituting the second core. The second material is not limited to a material that is deposited in a thin film shape in various ways above the first cladding layer in which the first core is formed.

For example, a support substrate in which a semiconductor layer is formed by growing a III-V group semiconductor crystal is first bonded to the first cladding layer, then the support substrate of the III-V group semiconductor is removed, and the semiconductor layer having a thickness of several hundreds of nanometers is formed on the first cladding layer. Thereafter, the first core and the second core formed from the semiconductor layer can be formed on the first cladding layer by patterning the first cladding layer and halfway patterning the semiconductor layer. Not only the III-V group compound semiconductor described above but also, for example, a well-known SOI (silicon on insulator) substrate can be used, and the second core can be formed from the surface silicon layer in the same manner as described above.

The bonding described above has an excellent advantage that for example, by using a bonding method such as normal temperature bonding based on a low temperature surface activation technology, a temperature rise at the time of forming a core layer can be reduced and the second core can be formed at equal to or less than the Curie point of the portion serving as the first core.

There is a concern that an undesired nonlinear optical effect is exhibited by strong optical confinement in both the optical waveguide including a core such as Si and the plasmonic optical waveguide. For this reason, a material that suppresses the undesired nonlinear optical effect with respect to an optical wavelength to be propagated is desirably used as the material of the core.

In the embodiments described above, examples in which the first material is lithium niobate have been described; however, embodiments of the present invention is not limited thereto. The first material may be, for example, a ferroelectric perovskite oxide crystal such as BaTiO3, LiNbO3, LiTaO3, or KTN, or a cubic perovskite oxide crystal such as KTN, BaTiO3, SrTiO3, or Pb3MgNb2O9. Furthermore, the first material may be a KDP crystal, a zincblende crystal, or the like.

The metal material constituting the metal layer only needs to be a metal capable of exciting surface plasmon polariton (SPP) at an interface between the first core and the second core with respect to light having a wavelength used when the plasmonic optical waveguide is formed, and for example, Au, Ag, Al, Cu, Ti, Pt, or the like can be applied.

Meanwhile, the present invention is not limited to the embodiment described above, and it will be obvious to those skilled in the art that various modifications and combinations can be implemented within the technical idea of the present invention.

### REFERENCE SIGNS LIST

101 . . . First cladding layer, 102 . . . First core, 103 . . . Second core, 104 . . . First metal layer, 105 . . . Second metal layer, 106 . . . Second cladding layer

1-7. (canceled)

8. An optical device comprising:
a first cladding layer comprising a first material having an electrooptical effect;
a first core on the first cladding layer and comprising the first material;
a second core on the first core and comprising a second material having a refractive index higher than a refractive index of the first material;
a first metal layer and a second metal layer on side surfaces of both of the first core and the second core; and
a second cladding layer on the first cladding layer and covering the first core, the second core, the first metal layer, and the second metal layer, wherein the first core, the second core, the first metal layer, and the second metal layer constitute a plasmonic optical waveguide.

9. The optical device according to claim 8, wherein the first metal layer and the second metal layer are in contact with the side surfaces of both of the first core and the second core.

10. The optical device according to claim 8, further comprising:
a bonding layer between the first core and the second core and comprising a third material having a refractive index lower than the refractive index of the second material.

11. The optical device according to claim 8, further comprising:
a layer between the side surfaces of both of the first and second cores and the first and second metal layers and comprising a third material having a refractive index lower than the refractive index of the second material.

12. The optical device according to claim 8, wherein in the first core and the second core, a mode conversion region in which a width in a plan view gradually expands in a waveguide direction is formed on an end side.

13. The optical device according to claim 8, wherein the first cladding layer and the first core are integrally formed.

14. The optical device according to claim 8, wherein the second core comprises at least one of silicon, InP, or AlGaAs.

15. A method comprising:
forming a first core on a first cladding layer, the first core and the first cladding layer comprising comprising a first material having an electrooptical effect;
forming a second core on the first core and comprising a second material having a refractive index higher than a refractive index of the first material;
forming a first metal layer and a second metal layer on side surfaces of both of the first core and the second core; and
forming a second cladding layer on the first cladding layer and covering the first core, the second core, the first metal layer, and the second metal layer, wherein the first core, the second core, the first metal layer, and the second metal layer constitute a plasmonic optical waveguide.

16. The method according to claim 15, wherein the first metal layer and the second metal layer are in contact with the side surfaces of both of the first core and the second core.

17. The method according to claim 15, further comprising:
forming a bonding layer on the first core, the bonding layer being between the first core and the second core and comprising a third material having a refractive index lower than the refractive index of the second material.

18. The method according to claim 15, further comprising:
forming a layer between the side surfaces of both of the first and second cores and the first and second metal layers and comprising a third material having a refractive index lower than the refractive index of the second material.

19. The method according to claim 15, wherein the first cladding layer and the first core are integrally formed.

20. The method according to claim 15, wherein the second core comprises at least one of silicon, InP, or AlGaAs.
